(19) United States
(12) Patent Application Publication
(10) Pub. No.: US 2026/0296513 A1
(43) Pub. Date: Oct. 1, 2026

(54) Cart with Foldable Tipping Bucket

(71) Applicant: Zhejiang Hengfeng Top Leisure Co., Ltd., Zhejiang (CN)

(72) Inventor: Baoqing Yang, Zhejiang (CN)

(21) Appl. No.: 19/479,605

(22) PCT Filed: Sep. 12, 2023
(86) PCT No.: PCT/CN2023/118255

§ 371 Date: Oct. 28, 2025

(30) Foreign Application Priority Data
May 5, 2023 (CN) 202321049260.9

(51) Int. Cl. B62B 3/02

(52) U.S. Cl. CPC B62B 3/02

(57) ABSTRACT

Provided is a cart with a foldable tipping bucket, comprising a cart body (100) and at least one tipping bucket (200). The tipping bucket (200) is pivotably arranged on the cart body (100). The cart body (100) comprises a plurality of vertical rods (11). A first connecting rod assembly and a second connecting rod assembly are arranged between the tipping bucket (200) and two adjacent vertical rods (11). The first connecting rod assembly and the second connecting rod assembly each comprise a slidable seat (13) and a connecting rod (14). The two slidable seats (13) are slidably arranged on the two adjacent vertical rods (11), respectively. The two connecting rods (14) are rotatably connected to the two slidable seats (13) at one end, respectively, and rotatably connected to the tipping bucket (200) at the other end.

### TECHNICAL FIELD

The present invention relates to a cart, in particular to a cart with a foldable tipping bucket.

### BACKGROUND

A folding cart is a cart can reduce its overall volume by being folded, so as to facilitate carrying and storage. It is used for shopping and other activities, so as to carry some purchased items and make it more convenient to carry lightweight items. The existing folding cart has a small space, so it can only store a few items and has great limitations in use. Therefore, how to solve the problem of small space and few stored items is an urgent problem to be solved by those skilled in the art.

Existing carts generally use a straight hinge and webbing to fix a tipping bucket frame of the cart, and connect the cart and the tipping bucket through soft connections (webbing, triangular pieces, etc.) and hard connections (straight hinges), and is opened by rotating the tipping bucket. Since the tipping bucket frame of the cart is fixed with a straight hinge and webbing, the strength of the tipping bucket is not high, and the soft connection method will cause problems such as tearing and aging during use, and the service life is not long. The straight hinge connection has a short lever arm, so the connection point may break during use, and there is a problem of too many operating steps.

### SUMMARY

The present invention provides a cart with a foldable tipping bucket, wherein the cart includes a cart body and at least one tipping bucket, and the tipping bucket is pivotally arranged on the cart body. The cart body includes multiple vertical rods, and a first connecting rod assembly and a second connecting rod assembly are provided between the tipping bucket and two adjacent vertical rods, and the first connecting rod assembly and the second connecting rod assembly both include a slidable seat and a connecting rod, and the two slidable seats are respectively slidably arranged on the two adjacent vertical rods, and the two connecting rods are respectively rotatably connected to the two slidable seats at one end, and are respectively rotatably connected to the tipping bucket at the other end.

Preferably, the two adjacent vertical rods are respectively provided with a limiting portion below the two slidable seats for limiting maximum displacements of the two slidable seats.

Preferably, the limiting portion includes a mounting seat provided on the vertical rod.

Preferably, the limiting portion includes a limiting block or a limiting rod, a mounting seat is provided on a middle side of the vertical rod, and the limiting block or the limiting rod is arranged above the mounting seat.

Preferably, the tipping bucket includes a first rod body, a second rod body arranged opposite to the first rod body, and a connecting member for connecting the first rod body and the second rod body, and the first connecting rod assembly and the second connecting rod assembly are respectively connected between two adjacent vertical rods and the first rod body and the second rod body.

Preferably, the connecting member includes a first connecting rod extending obliquely from left to right and a second connecting rod extending obliquely from right to left, and the first connecting rod and the second connecting rod are arranged crosswise.

Preferably, the tipping bucket is pivotally provided on at least one of a front side, a rear side, a left side or a right side of the cart body.

Preferably, the cart is a double-layer cart, wherein the double-layer cart comprises an upper layer bottom frame and a lower layer bottom frame, and the tipping bucket is pivotally arranged behind the lower layer bottom frame so that the tipping bucket is able to be in a same plane as the lower layer bottom frame.

Preferably, the upper layer bottom frame is foldably connected to a middle position between a front frame and a rear frame, and the lower layer bottom frame is foldably connected to a bottom side position between the front frame and the rear frame.

Preferably, the front and rear ends of the first rod body and the second rod body are both provided with connecting seats, the connecting seats at the front ends of the first rod body and the second rod body are suitable for pivotal connection with the cart body, and two ends of the first connecting rod and the second connecting rod respectively connect the first rod body and the second rod body through the connecting seats.

Preferably, a first mounting seat and a second mounting seat are provided at both the middle position and bottom of the two adjacent vertical rods, a setting height of the limiting portion is higher than a setting height of the first mounting seat, and the two connecting rods are respectively connected to middle positions of a left rod body and a right rod body.

Preferably, the cart further includes side frames, wherein the front frame, the rear frame and the side frames define an upper storage space, and the side frames include multiple groups of cross connection assemblies.

Preferably, the upper layer bottom frame and the lower layer bottom frame each include a rotating hub and four bottom rods rotatably connected to the rotating hub.

Preferably, a length of the tipping bucket is retractable.

The tipping bucket provided by the present invention is linked to the cart body through a slidable seat and a connecting rod, has a longer lever arm, and significantly increases the connection strength. In addition, when the tipping bucket needs to be folded, the tipping bucket can be just lifted up by hand and easily stored, making storage convenient. When the tipping bucket needs to be opened, the tipping bucket is pulled by hand, and the slidable seat slides to the limiting portion, and the tipping bucket is horizontally unfolded to increase the storage space. When the tipping bucket and the bottom frame are at a same level, the length of the cart body can be extended and longer items can be placed.

### BRIEF DESCRIPTION OF DRAWINGS

FIG. 1 is a schematic structural diagram of a cart provided in Embodiment 1 of the present invention;

FIG. 2 is a side view of the cart provided in Embodiment 1 of the present invention;

FIGS. 3 and 4 are schematic diagrams of the folding process of the cart provided in Embodiment 1 of the present invention.

FIG. 5 is a schematic structural diagram of a cart provided in Embodiment 1 of the present invention;

FIG. 6 is a schematic structural diagram of the cart provided in Embodiment 2 of the present invention.

### DETAILED DESCRIPTION OF EMBODIMENTS

The present invention or the technical solution of the invention will be further described in detail below through specific embodiments and in combination with the drawings.

In the description of the present invention, it should be understood that the terms “front”, “rear”, “up”, “down”, “left”, “right”, etc., indicating orientations or positional relationships, are based on the orientations or positional relationships shown in the drawings, and are only for the convenience of describing the present invention and simplifying the description, rather than indicating or implying that the device or element referred to must have a specific orientation, be constructed and operated in a specific orientation, and therefore should not be understood as a limitation on the present invention.

In the description of the present invention, it should be noted that, unless otherwise specified and limited, the terms “mount” and “connection” should be understood in a broad sense. For example, it can be a mechanical connection or an electrical connection, or it can be the internal communication between two elements. It can be a direct connection or an indirect connection through an intermediate medium. For those ordinarily skilled in the art, the specific meanings of the above terms can be understood according to specific circumstances.

### Embodiment 1

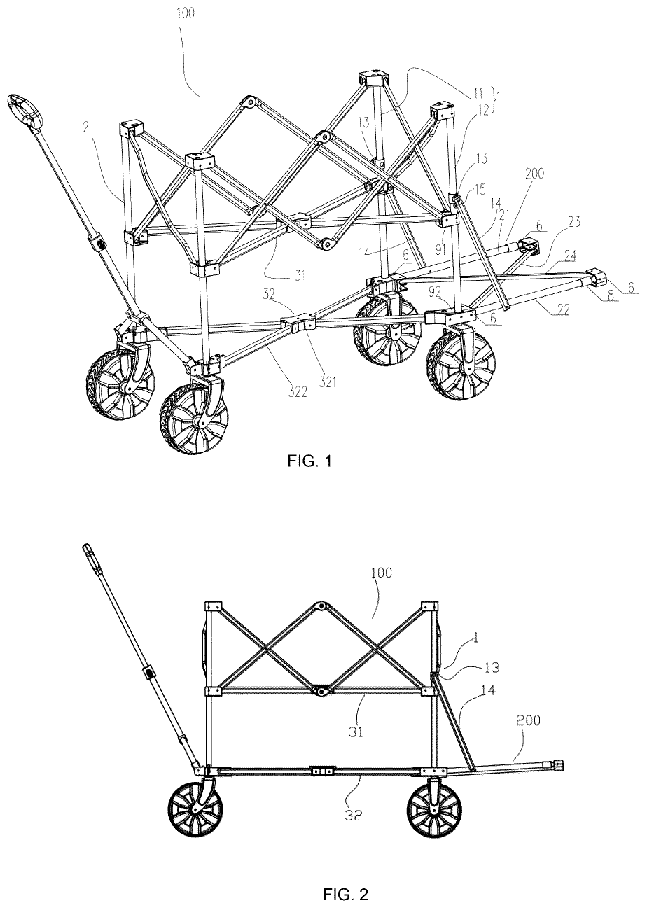

With reference to FIGS. 1-2, this embodiment provides a cart with a foldable tipping bucket, wherein the cart includes a cart body 100 and at least one tipping bucket 200. The tipping bucket 200 is pivotally provided on the cart body 100, and the tipping bucket 200 can be tipped relative to the cart body 100 to be in an open or folded state. The cart body includes multiple vertical rods. In this embodiment, the cart body includes four vertical rods. A first connecting rod assembly and a second connecting rod assembly are provided between the tipping bucket 200 and the two adjacent vertical rods 11, 12. The first connecting rod assembly and the second connecting rod assembly each includes a slidable seat 13 and a connecting rod 14. The slidable seats 13 of the first connecting rod assembly and the second connecting rod assembly are respectively slidably arranged on the two adjacent vertical rods 11, 12. The connecting rods 14 of the first connecting rod assembly and the second connecting rod assembly are rotatably connected to the two slidable seats 13 at one end, respectively, and are rotatably connected to the tipping bucket 200 at the other end. In this way, the tipping bucket added to the existing cart body increases the storage space. In addition, compared with the existing hinge structure and soft structures such as webbing, the slidable seat and connecting rod structure provided in this embodiment has a significantly longer lever arm and significantly increased connection strength, which solves the problems of easy breakage and low strength of the existing tipping bucket connection mechanism.

In some embodiments, the cart is a foldable double-layer cart, and a middle side of the vertical rod is provided with a plurality of mounting seats for connecting a cross-link assembly, and the mounting seats are suitable for limiting the sliding of the slidable seats.

In some preferred embodiments, the two adjacent vertical rods 11 and 12 are respectively provided with a limiting portion under the two slidable seats for limiting maximum displacements of the two slidable seats, so that the limiting portion can limit the downward movement distance of the slidable seat so that the slidable seat can move to a preset distance.

In some specific embodiments, the cart body is a foldable cart, and the four vertical rods of the cart are connected by multiple groups of cross-link assemblies to achieve folding and unfolding functions. A mounting seat is provided on the middle side of the multiple groups of vertical rods to realize a mounting of the cross-link assembly. The mounting seat can limit the sliding displacement of the slidable seat to play a limiting function. The mounting seat constitutes the aforementioned limiting portion. As an example, when the cart is a double-layer cart, a first mounting seat 91 and a second mounting seat 92 are provided at both the middle positions and bottoms of the two adjacent vertical rods 11, 12. The first mounting seat 91 is used to mount a side frame and an upper layer bottom frame. A lower layer bottom frame 32 is rotatably connected on the second mounting seat 92. Wheels are mounted at the bottom of the second mounting seat 92. The overall structure has a small volume when folded and a stable and strong structure. The first mounting seat 91 has the function of limiting the maximum displacement of the slidable seat, that is, the first mounting seat 91 constitutes the aforementioned limiting portion.

In other specific embodiments, the limiting portion includes a limiting block or a limiting rod, a mounting seat is provided on the middle side of the vertical rod, and the limiting block or the limiting rod is arranged above the mounting seat. As an example, the two adjacent vertical rods 11 and 12 are respectively provided with limiting blocks 15 below the two slidable seats for limiting the maximum displacements of the two slidable seats. In this way, the limiting blocks 15 can limit the downward movement distance of the slidable seats so that the slidable seats can move to a preset distance. For example, since the presence of the first mounting seat 91 in the middle position between the two adjacent vertical rods 11 and 12 will block the sliding of the slidable seat, a setting height of the limiting block 15 is higher than the setting height of the upper first mounting seat 91, and the left connecting rod and the right connecting rod are respectively connected to the middle position of the first rod body and the second rod body. In this way, while ensuring that the tipping bucket can be freely folded and unfolded, the setting of the slidable seat will not interfere with the upper layer bottom frame. In some examples, the first rod body 21 and the second rod body 22 are retractable sleeves 8, so that the tipping bucket can be switched to the folded position.

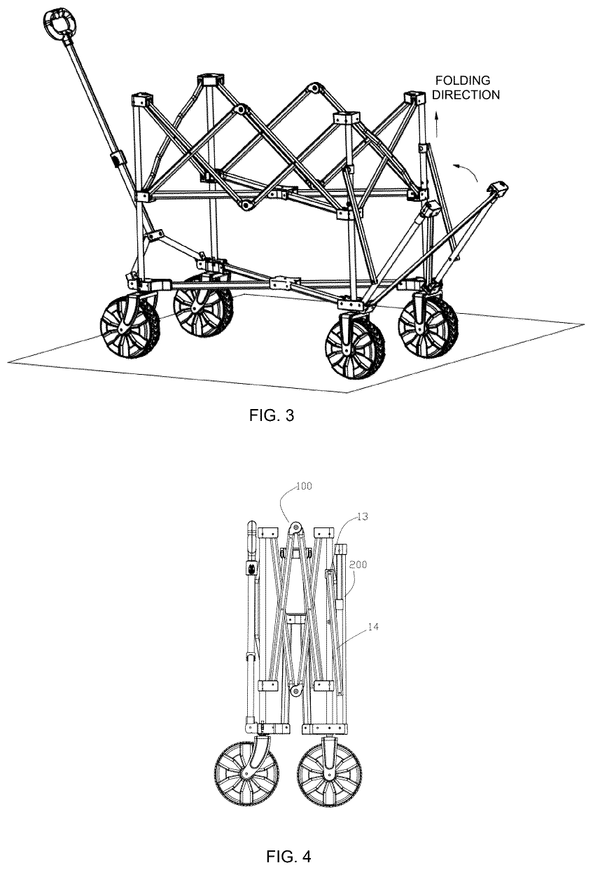

Please refer to FIGS. 3 and 4, when the tipping bucket needs to be folded, the tipping bucket is lifted up by hand, and the slidable seats slide along the two adjacent vertical rods 11 and 12. Then the connecting rod drives the tipping bucket to pivot and fold, and the cart is easy and convenient to store. When the tipping bucket needs to be opened, the tipping bucket is pulled by hand, and the slidable seats slide to the limiting portion, and the tipping bucket is then unfolded horizontally to increase the storage space. When the tipping bucket and the bottom frame are at the same level, the length of the cart body can be extended and longer items can be placed.

In some embodiments, the tipping bucket can be arranged on any one or more sides of the cart, namely the front side, the left side, the right side or the rear side. In some specific embodiments, the cart body has a front frame 2 and a rear frame 1 that are arranged relative to each other, and the tipping bucket 1 is pivotally provided on the rear frame.

In order to ensure a vertical pivoting of the tipping bucket so that it is in a state of being perpendicular to and horizontally overlapped with the rear frame of the cart. The tipping bucket 200 includes a first rod body 21, a second rod body 22 arranged opposite to the first rod body 21, and a connecting member for connecting the first rod body 21 and the second rod body 22. The first connecting rod assembly is connected between one vertical rod 11 of the two adjacent vertical rods and the first rod body 21, and the second connecting rod assembly is connected between the other vertical rod 12 and the second rod body 22. In this way, the first rod body 21 and the second rod body 22 can be pivoted from the unfolded state to the folded state under the drive of the first connecting rod assembly and the second connecting rod assembly, that is, vertical pivoting is achieved. It is understandable that the provision of the connecting member ensures that the first rod body 21 and the second rod body 22 are connected to each other while ensuring a linkage effect with the cart body so as to make it to be used as a tipping bucket frame. Specifically, in this embodiment, the connecting member includes a first connecting rod 23 extending obliquely from left to right and a second connecting rod 24 extending obliquely from right to left. The first connecting rod 23 and the second connecting rod 24 are arranged crosswise. In this way, the first rod body and the second rod body and the first connecting rod and the second connecting rod constitute the tipping bucket frame as a whole, which folds upward and unfolds downward as a whole.

In some preferred embodiments, as shown in FIG. 1, the cart is a double-layer cart, wherein the double-layer cart includes an upper layer bottom frame 31 and a lower layer bottom frame 32, and the tipping bucket 200 is pivotally disposed behind the lower layer bottom frame 32 so that the tipping bucket can be in the same plane as the lower layer bottom frame.

Specifically, the upper layer bottom frame 31 is foldably connected to a middle position between the front frame 2 and the rear frame 1, and the lower layer bottom frame 32 is foldably connected to a bottom side position between the front frame 2 and the rear frame 1. It should be noted that the “middle position” mentioned in this application refers to the middle position in a broad sense, that is, any position between the front end and the rear end can be understood as the “middle position”. The “same plane” mentioned in this application refers to the same plane in a broad sense, as long as the bottom frame and the tipping bucket can be basically kept level to achieve the purpose of extending a length of the cart body.

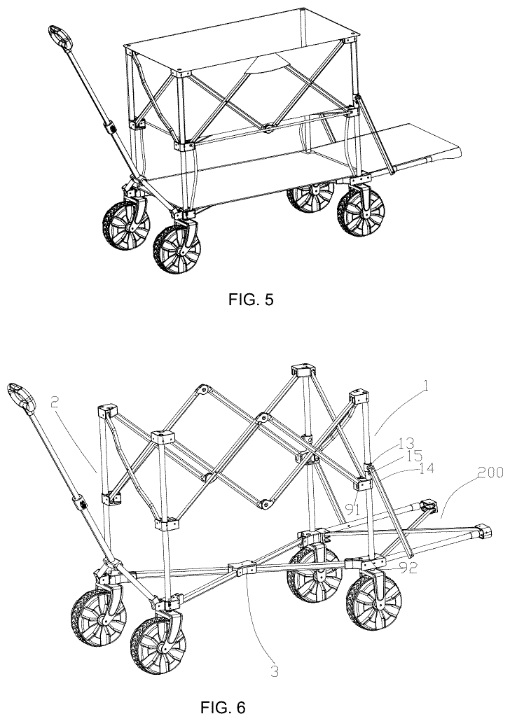

In this way, referring to FIG. 5, the soft surface is provided on the cart, and the upper layer bottom frame 31 is combined with the front frame 2 and the rear frame 1 to form a storage cavity with an upper opening. Specifically, the upper storage space is defined by the side frames among the front frame, the rear frame, and the upper layer bottom frame, and the side frame includes multiple groups of cross connection assemblies. A plane is formed among the lower layer bottom frame 32 and the front frame 2 and the rear frame 1 for storing items. At this time, a pivot of the tipping bucket is provided on the rear side of and in the same plane with the lower layer bottom frame, which significantly extends the body length of the lower layer bottom frame. It not only increases the storage space, but also can extend the body length to place longer items.

In this embodiment, the front and rear ends of the first rod body 21 and the second rod body 22 are both provided with connecting seats 6, and two ends of the first connecting rod 23 and the second connecting rod 24 respectively connect the first rod body 21 and the second rod body 22 through the connecting seats 6. Furthermore, the connecting seat 6 at the front end of the first rod body 21 and the second rod body 22 is suitable for pivotal connection with the cart body 100. Specifically, the upper layer bottom frame and the lower layer bottom frame both include a rotating hub 321 and four bottom rods 32 rotatably connected to the rotating hub.

In the double-layer cart, a first mounting seat 91 and a second mounting seat 92 are provided at both the middle position and bottom of the two adjacent vertical rods 11 and 12. The first mounting seat 91 is used to mount the side frame and the upper layer bottom frame. The lower layer bottom frame 32 is rotatably connected to the second mounting seat 92. Wheels are mounted at the bottom of the second mounting seat 92. The overall structure has a small volume when folded and a stable and strong structure.

The tipping bucket provided by the present invention is linked to the cart body through a slidable seat and a connecting rod, has a longer lever arm, and significantly increases the connection strength. In addition, when the tipping bucket needs to be folded, it can be easily stored by lifting the tipping bucket up by hand, which is convenient for storage. When the tipping bucket needs to be opened, the tipping bucket is pulled by hand, and the slidable seat slides to the limiting portion, and the tipping bucket is horizontally unfolded to increase the storage space. When the tipping bucket and the bottom frame are at the same level, the length of the cart body can be extended and longer items can be placed.

### Embodiment 2

Referring to FIG. 6, the cart provided in this embodiment is basically the same as the cart provided in Embodiment 1. The only difference is that the cart provided in Embodiment 2 has only one bottom frame 3 located at the bottom of the front frame 2 and the rear frame 1, that is, it is a kind of single-layer cart. A storage space is also formed among the front frame 2, the rear frame 1 and the side frames of the upper layer, but there is no frame support at the bottom. The bottom frame 3 itself and the tipping bucket form an extended placement table. The first mounting seat here is for mounting the side frame, and the setting height of the limiting block 15 is also higher than the setting height of the upper first mounting seat 91.

In the description of this specification, the reference terms “one embodiment”, “some embodiments”, “specific examples”, or “some examples” mean that the specific features, structures, materials or characteristics described in combination with the embodiment or example are included in at least one embodiment or example of the present invention. In this specification, the schematic expressions of the above terms do not necessarily refer to the same embodiment or example. Furthermore, the specific features, structures, materials, or characteristics described may be combined in any suitable manner in any one or more embodiments or examples.

While embodiments of the present invention have been shown and described, it will be appreciated by those ordinarily skilled in the art that various changes, modifications, substitutions, and variations may be made to the embodiments without departing from the principles and spirit of the invention, and that the scope of the invention is defined by the claims and their equivalents.

1. A cart comprising: a cart body and at least one tipping bucket, and the at least one tipping bucket is pivotally arranged on the cart body; the cart body comprises a plurality of vertical rods, a first connecting rod assembly and a second connecting rod assembly are provided between the tipping bucket and two adjacent vertical rods, the first connecting rod assembly and the second connecting rod assembly each comprises a slidable seat and a connecting rod, each of the slidable seats is slidably arranged on one of the two adjacent vertical rods, respectively, and each of the connecting rods is respectively rotatably connected to one of the two slidable seats at one end, and rotatably connected to the tipping bucket at the other end, respectively.

2. The cart according to claim 1, wherein the two adjacent vertical rods are respectively provided with a limiting portion below the two slidable seats, each limiting portion being configured for limiting a maximum sliding displacements of each of the two slidable seats on the respective vertical rod.

3. The cart according to claim 2, wherein the limiting portion includes a mounting seat provided on the vertical rod.

4. The cart according to claim 2, wherein the limiting portion comprises one of a limiting block and a limiting rod, a mounting seat is provided on a middle side of the vertical rod, and the one of the limiting block and the limiting rod is arranged above the mounting seat.

5. The cart according to claim 1, wherein the tipping bucket comprises a first rod body, a second rod body arranged opposite to the first rod body, and a connecting member for connecting the first rod body and the second rod body, and the first connecting rod assembly and the second connecting rod assembly are respectively connected between two adjacent vertical rods and the first rod body and the second rod body.

6. The cart according to claim 5, wherein the connecting member comprises a first connecting rod extending obliquely from left to right and a second connecting rod extending obliquely from right to left, and the first connecting rod and the second connecting rod are arranged crosswise.

7. The cart according to claim 1, wherein the tipping bucket is pivotally provided on at least one of a front side, a rear side, a left side or a right side of the cart body.

8. The cart according to claim 1, wherein the cart comprises an upper layer bottom frame and a lower layer bottom frame, and the tipping bucket is pivotally arranged adjacent to the lower layer bottom frame so that the tipping bucket is able to be in a same plane as the lower layer bottom frame.

9. The cart according to claim 8, wherein the upper layer bottom frame is foldably connected to a middle position between a front frame and a rear frame, and the lower layer bottom frame is foldably connected to a bottom side position between the front frame and the rear frame.

10. The cart according to claim 6, wherein front ends and rear ends of the first rod body and the second rod body are both provided with connecting seats, the connecting seats at the front ends of the first rod body and the second rod body are suitable for pivotal connection with the cart body, and two ends of the first connecting rod and the second connecting rod respectively connect the first rod body and the second rod body through the connecting seats.

11. The cart according to claim 4, wherein a first mounting seat and a second mounting seat are provided at both a middle position and a bottom position of the two adjacent vertical rods, a setting height of the limiting portion is higher than a setting height of the first mounting seat, and the two connecting rods are respectively connected to middle positions of a left rod body and a right rod body.

12. The cart according to claim 9, wherein the cart further comprises side frames, and the front frame, the rear frame and the side frames define an upper storage space, and the side frames comprise multiple groups of cross connection assemblies.

13. The cart according to claim 8, wherein the upper layer bottom frame and the lower layer bottom frame each comprise a rotating hub and four bottom rods rotatably connected to the rotating hub.

14. The cart according to claim 1, wherein a length of the tipping bucket is retractable.

15. The cart according to claim 5 wherein the first rod body and the second rod body are retractable sleeves.
